(19) United States
(12) Patent Application Publication
(10) Pub. No.: US 2025/0148794 A1
(43) Pub. Date: May 8, 2025

(54) METHOD AND APPARATUS FOR LEFT-BEHIND OBJECT DETECTION, AND STORAGE MEDIUM

(71) Applicant: BOE TECHNOLOGY GROUP CO., LTD., Beijing (CN)

(72) Inventor: Fei LI, Beijing (CN)

(73) Assignee: BOE TECHNOLOGY GROUP CO., LTD., Beijing (CN)

(21) Appl. No.: 18/726,120

(22) PCT Filed: Jan. 4, 2023
(86) PCT No.: PCT/CN2023/070248

§ 371 Date: Jul. 2, 2024

(30) Foreign Application Priority Data
Jan. 26, 2022 (CN) 202210096074.4

(51) Int. Cl. G06V 20/52; G06V 10/25; G06V 10/28; G06V 10/75; G06V 10/82

(52) U.S. Cl. CPC G06V 20/52; G06V 10/25; G06V 10/28; G06V 10/751; G06V 10/82

(57) ABSTRACT

A method for left-behind object detection includes: acquiring a first to-be-detected image of a target region at a first moment; determining whether a foreground image exists in the first to-be-detected image according to a foreground image determination model, the foreground image being an image corresponding to a foreground object in the target region; if the foreground image exists in the first to-be-detected image and the foreground image satisfies a first preset condition, inputting the foreground image and at least one comparison image into a preset tracking model to obtain at least one tracking result; and detecting whether the foreground object is an object left behind in the target region according to the at least one tracking result.

### CROSS-REFERENCE TO RELATED APPLICATIONS

This application is a national phase entry under 35 USC 371 of International Patent Application No. PCT/CN2023/070248, filed on Jan. 4, 2023, which claims priority to Chinese Patent Application No. 202210096074.4, filed on Jan. 26, 2022, which are incorporated herein by reference in their entirety.

### TECHNICAL FIELD

The present disclosure relates to the field of video monitoring, and in particular, to a method and apparatus for left-behind object detection, and a storage medium.

### BACKGROUND

In the field of video monitoring, the left-behind object detection can be applied to a variety of scenarios. For example, detecting left-behind objects in public regions may discover missing items in time and alert the police to avoid property damage. Detecting object retention in critical regions may discover object obstruction issues in time and alert to eliminate safety hazards.

At present, in the related art, whether there is a foreground object is generally determined by detecting whether a pixel value of a pixel in an image changes greatly. When the pixel value in the monitoring screen changes suddenly due to factors such as illumination changes, this solution will determine a pixel with a sudden change in pixel value as a foreground pixel, resulting in low detection accuracy of foreground objects.

### SUMMARY

In an aspect, a method for left-behind object detection is provided. The method includes: acquiring a first to-be-detected image of a target region at a first moment; determining whether a foreground image exists in the first to-be-detected image according to a foreground image determination model, the foreground image being an image corresponding to a foreground object in the target region; in a case where the foreground image exists in the first to-be-detected image and the foreground image satisfies a first preset condition, inputting the foreground image and at least one comparison image into a preset tracking model to obtain at least one tracking result, wherein the at least one comparison image is an image of the target region within a second time period, the second time period is a time period after the first moment, and the first preset condition includes at least one of: a ratio of an area of the foreground image to an area of the first to-be-detected image being greater than a first threshold, and a number of pixels of the foreground image being greater than a second threshold; and detecting whether the foreground object is an object left behind in the target region according to the at least one tracking result.

In some embodiments, the foreground image determination model includes one or more sub-models corresponding to a position of each pixel in a background image of the target region, the background image does not include the foreground image, and the method includes: detecting whether each first pixel of the first to-be-detected image matches one or more sub-models of a corresponding second pixel, the second pixel being a pixel corresponding to a position of the first pixel in the background image; in a case where at least one first pixel does not match one or more sub-models of a corresponding second pixel, determining that the foreground image exists in the first to-be-detected image; and in a case where all first pixels match sub-models of corresponding second pixels, determining that the foreground image does not exist in the first to-be-detected image.

In some embodiments, the method includes: determining a parameter value of any first pixel of the first to-be-detected image and a parameter interval of each sub-model of one or more sub-models of a second pixel corresponding to the first pixel; in a case where the parameter value of the first pixel is within a parameter interval of a first sub-model, determining that the first pixel matches the first sub-model, the first sub-model being at least one sub-model of the one or more sub-models of the second pixel corresponding to the first pixel; and in a case where the parameter value of the first pixel is outside the parameter interval of the first sub-model, determining that the first pixel does not match the first sub-model.

In some embodiments, the preset tracking model includes at least one neural network model; and the method includes: inputting the foreground image into a first neural network model to obtain a first image feature of the foreground image, the first neural network model being any neural network model in the at least one neural network model; inputting each of the at least one comparison image into a second neural network model to obtain a second image feature corresponding to each comparison image of the at least one comparison image, the second neural network model being any neural network model except the first neural network in the at least one neural network model; and comparing the first image feature with the second image feature corresponding to each comparison image to obtain the at least one tracking result.

In some embodiments, the at least one tracking result includes at least one of a first parameter value, a range of a tracking image, or a tracking position; wherein the tracking image is a sub-image with a highest similarity to the foreground image in the comparison image, the first parameter value is used to indicate a similarity between the foreground image and the tracking image, and the range of the tracking image is a region occupied by the tracking image in the comparison image, and the tracking position is a position of the tracking image in the comparison image.

In some embodiments, the method includes: in a case where the at least one tracking result satisfies a second preset condition, determining that the foreground object is the object left behind in the target region, the second preset condition including at least one restrictive condition that corresponds to the at least one tracking result; and in a case where any one of the at least one tracking result does not satisfy the second preset condition, determining that the foreground object is not the object left behind in the target region.

In some embodiments, the method includes: in a case where the first parameter value is greater than a third threshold, and/or the range of the tracking image is greater than a fourth threshold, and/or the tracking position is within at least one preset range in the comparison image, determining that the foreground object is the object left behind in the target region.

In some embodiments, before the inputting the foreground image and at least one comparison image into a preset tracking model to obtain at least one tracking result, the method further includes: acquiring one or more background images; determining a background sub-image of each background image of the one or more background images, a position of the background sub-image in the background image corresponding to a position of the foreground image in the first to-be-detected image; inputting the foreground image and the one or more background sub-images into a verification model to obtain at least one second parameter value, the second parameter value is used to indicate a similarity between the foreground image and the background sub-image; and in a case where the at least one second parameter value is less than a fifth threshold, determining that the foreground image exists in the first to-be-detected image.

In some embodiments, the method further includes: in a case where the foreground image does not exist in the first to-be-detected image, or the foreground image does not satisfy the first preset condition, or the foreground object is not the object left behind in the target region, updating the foreground image determination model.

In some embodiments, the method includes: determining an updated image, the updated image being the first to-be-detected image; and updating the foreground image determination model according to the updated image to obtain an updated foreground image determination model.

In some embodiments, the method includes: for each third pixel in the updated image, detecting whether a sub-model matching the third pixel exists in one or more sub-models corresponding to a second pixel, the second pixel being a pixel corresponding to a position of the third pixel in the background image; in a case where a second sub-model exists in the one or more sub-models, increasing a weight value of the second sub-model and decreasing a weight value of a third sub-model, the second sub-model being the sub-model matching the third pixel in the one or more sub-models, and the third sub-model being a sub-model except the second sub-model in the one or more sub-models; and obtaining the updated foreground image determination model according to an increased weight value of the second sub-model and a decreased weight value of the third sub-model.

In some embodiments, the method includes: in a case where the second sub-model does not exist in the one or more sub-models, generating a fourth sub-model according to the third pixel; and replacing a sub-model with a minimum weight value in the one or more sub-models with fourth sub-model to obtain the updated foreground image determination model.

In some embodiments, the method further includes: acquiring a second to-be-detected image of the target region at a second moment, the second moment being a moment after the first moment; determining whether the foreground image exists in the second to-be-detected image according to the foreground image determination model; in a case where the foreground image exists in the second to-be-detected image and the foreground image satisfies a first preset condition, inputting the foreground image and at least one second comparison image into the preset tracking model to obtain at least one tracking result, wherein the at least one second comparison image is an image of the target region within a third time period, the third time period is a time period after the second moment, and the first preset condition includes at least one of: a ratio of the area of the foreground image to an area of the second to-be-detected image being greater than the first threshold, and the number of pixels of the foreground image being greater than the second threshold; and detecting whether the foreground object is the object left behind in the target region according to the at least one tracking result.

In some embodiments, the method further includes: in a case where the foreground object is the object left behind in the target region, outputting prompt information.

In yet another aspect, a non-transitory computer-readable storage medium is provided. The non-transitory computer-readable storage medium has stored thereon computer program instructions that, when executed by a computer (e.g., a left-behind object detection apparatus), cause the computer to perform the method for left-behind object detection as described in any one of the above embodiments.

In yet another aspect, a computer program product is provided. The computer program product includes computer program instructions that, when executed by a computer (e.g., a left-behind object detection apparatus), cause the computer to perform the method for left-behind object detection as described in any one of the above embodiments.

In yet another aspect, a chip is provided. The chip includes a processor and a communication interface, the communication interface is coupled to the processor, and the processor is used to run a computer program or instructions to implement the method for left-behind object detection as described in any of the above embodiments.

In some embodiments, the chip provided in the present disclosure further includes a memory for storing the computer program or the instructions.

It should be noted that all or part of the above computer instructions can be stored on a computer-readable storage medium. The computer-readable storage medium can be packaged together with the processor of the apparatus, or may be packaged separately with the processor of the apparatus, which is not limited in the present disclosure.

In yet another aspect, a left-behind object detection system is provided, which includes: a left-behind object detection apparatus and at least one camera device. The left-behind object detection apparatus is configured to perform the method for left-behind object detection as described in any one of the above embodiments.

In the present disclosure, the name of the left-behind object detection apparatus does not limit the devices or functional modules, and in practical implementations, these devices or functional modules can be provided with other names. As long as the functions of the devices or functional modules are similar to those of the present disclosure, they fall within the scope of the claims of the present disclosure and their equivalent technologies.

### BRIEF DESCRIPTION OF THE DRAWINGS

In order to describe technical solutions in the present disclosure more clearly, the accompanying drawings to be used in some embodiments of the present disclosure will be introduced briefly. However, the accompanying drawings to be described below are merely drawings of some embodiments of the present disclosure, and a person of ordinary skill in the art can obtain other drawings according to those drawings. In addition, the accompanying drawings in the following description may be regarded as schematic diagrams, but are not limitations on actual sizes of products, actual processes of methods and actual timings of signals involved in the embodiments of the present disclosure.

FIG. 1 is a structural diagram of a system for left-behind object detection, in accordance with some embodiments;

FIG. 2 is a flowchart of a method for left-behind object detection, in accordance with some embodiments;

FIG. 3 is a diagram showing a scenario of a background image and a first to-be-detected image, in accordance with some embodiments;

FIG. 4 is a diagram showing a scenario of a first to-be-detected image and a comparison image, in accordance with some embodiments;

FIG. 5 is a flowchart of another method for left-behind object detection, in accordance with some embodiments;

FIG. 6 is a flowchart of yet another method for left-behind object detection, in accordance with some embodiments;

FIG. 7 is a structural diagram of a preset tracking model, in accordance with some embodiments;

FIG. 8 is a flowchart of yet another method for left-behind object detection, in accordance with some embodiments;

FIG. 9 is a flowchart of yet another method for left-behind object detection, in accordance with some embodiments;

FIG. 10 is a diagram showing another scenario of a background image and a first to-be-detected image, in accordance with some embodiments;

FIG. 11 is a flowchart of yet another method for left-behind object detection, in accordance with some embodiments;

FIG. 12 is a flowchart of yet another method for left-behind object detection, in accordance with some embodiments;

FIG. 13 is a structural diagram of an apparatus for left-behind object detection, in accordance with some embodiments; and

FIG. 14 is a structural diagram of another apparatus for left-behind object detection, in accordance with some embodiments.

### DETAILED DESCRIPTION

The technical solutions in some embodiments of the present disclosure will be described clearly and completely with reference to the accompanying drawings. However, the described embodiments are merely some but not all of embodiments of the present disclosure. All other embodiments obtained on the basis of the embodiments of the present disclosure by a person of ordinary skill in the art shall be included in the protection scope of the present disclosure.

Unless the context requires otherwise, throughout the description and claims, the term “comprise” and other forms thereof such as the third-person singular form “comprises” and the present participle form “comprising” are construed as an open and inclusive meaning, i.e., “included, but not limited to”. In the description of the specification, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, specific features, structures, materials, or characteristics described herein may be included in any one or more embodiments or examples in any suitable manner.

Hereinafter, the terms such as “first” and “second” are used for descriptive purposes only, but are not to be construed as indicating or implying the relative importance or implicitly indicating the number of indicated technical features. Thus, the features defined with “first” and “second” may explicitly or implicitly include one or more of the features. In the description of the embodiments of the present disclosure, the terms “a plurality of”, “the plurality of” and “multiple” each mean two or more unless otherwise specified.

Some embodiments may be described using the terms “coupled”, “connected” and their derivatives. For example, the term “connected” may be used in the description of some embodiments to indicate that two or more components are in direct physical or electrical contact with each other. As another example, the term “connected” may be used in the description of some embodiments to indicate that two or more components are in direct physical or electrical contact. However, the term “coupled” or “communicatively coupled” may also mean that two or more components are not in direct contact with each other, but still cooperate or interact with each other. The embodiments disclosed herein are not necessarily limited to the context herein.

The phrase “at least one of A, B and C” has the same meaning as the phrase “at least one of A, B or C”, both including following combinations of A, B and C: only A, only B, only C, a combination of A and B, a combination of A and C, a combination of B and C, and a combination of A, B and C.

The phrase “A and/or B” includes following three combinations: only A, only B, and a combination of A and B.

As used herein, the term “if” is, optionally, construed to mean “when” or “in a case where” or “in response to determining” or “in response to detecting”, depending on the context. Similarly, the phrase “if it is determined” or “if [a stated condition or event] is detected” is, optionally, construed to mean “in a case where it is determined” or “in response to determining” or “in a case where [the stated condition or event] is detected” or “in response to detecting [the stated condition or event]”, depending on the context.

The use of “applicable to” or “configured to” herein means an open and inclusive expression, which does not exclude devices that are applicable to or configured to perform additional tasks or steps.

In addition, the use of the phrase “based on” or “according to” is meant to be open and inclusive, since a process, step, calculation or other action that is “based on” or “according to” one or more of the stated conditions or values may, in practice, be based on or according to additional conditions or values exceeding those stated.

The term such as “about”, “substantially” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

Terms involved in the embodiments of the present disclosure will be explained below to facilitate readers' understanding.

### (1) Gaussian Distribution

Gaussian distribution, also known as normal distribution, is used to indicate the probability distribution of variables, and its corresponding function image has the image characteristics of low on both sides, high in the middle, and symmetrical on the left and right. The Gaussian distribution has two parameters, i.e., mean and variance. The mean is the variable value when the probability density of the Gaussian distribution is maximum, and the variance is used to indicate the decline of the function image. The variance is the square of the standard deviation, so the variance and the standard deviation can be converted to each other.

### (2) Neural Network

Neural networks (NNs), also known as artificial neural networks (ANNs), are mathematical model algorithms that imitate the behavior characteristics of animal neural networks and perform distributed parallel information processing. Neural networks include deep learning networks, such as convolutional neural networks (CNNs), long short-term memory (LSTM), etc.

### (3) Region of Interest (ROI)

Region of interest is a region required to be processed, which is selected from a processed image through a box, circular or irregular-shaped window. For example, in the present disclosure, a foreground image determined from a to-be-detected first image is the ROI required in the present disclosure.

Implementation manners in the embodiments of the present disclosure will be described in details below with reference to the accompanying drawings.

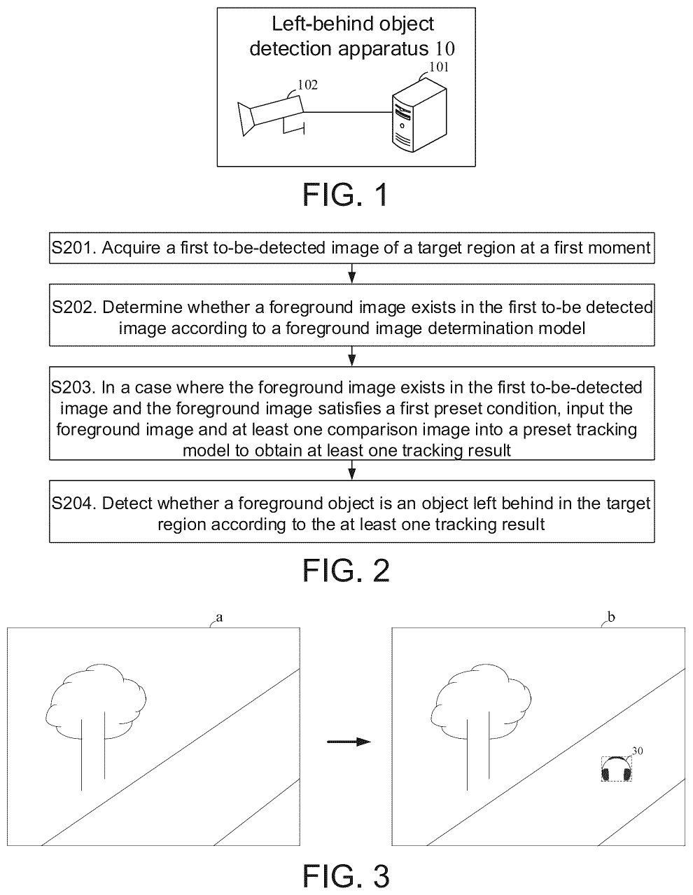

As shown in FIG. 1, FIG. 1 is a schematic structural diagram of a left-behind object detection system 10 according to some embodiments. The left-behind object detection system 10 includes: a left-behind object detection apparatus 101 and at least one camera device 102 (FIG. 1 shows only one camera device). The left-behind object detection apparatus 101 is connected to the at least one camera device 102 through a communication link. The communication link is a wired communication link or a wireless communication link, which is not limited here.

The camera device 102 is used to acquire image data of a target region, and send the image data to the left-behind object detection apparatus 101. Accordingly, the left-behind object detection apparatus 101 receives the image data sent by the camera device 102.

For example, the target region is an airport waiting region, fire exit, sewer, building stair passage and other regions that need to be monitored.

In a possible implementation manner, the camera device 102 can acquire the image data of the target region in real time and send it to the left-behind object detection apparatus 101, or the camera device 102 can also acquire the image data of the target region according to a preset frequency and send it to the left-behind object detection apparatus 101.

The camera device 102 in the embodiments of the present disclosure is a device that expresses image information with an analog signal or a digital signal through a photoreceptor, and it may be deployed on land, including indoor or outdoor, in hand or in vehicle. It can also be deployed on water (such as a ship). It can also be deployed in the air (such as an aircraft, a balloon and a satellite). For example, the camera device 102 includes a webcam, a video camera, or a camera. The camera device 102 may also be a device with a camera function. For example, the camera device 102 is a mobile phone, a tablet computer, a notebook computer, a handheld computer, a wearable device (such as a smart watch, a smart bracelet, and a pedometer) with a camera function, and vehicle-mounted equipment and flight equipment (such as an intelligent robot, a hot air balloon, a drone, and an airplane), etc.

For example, the camera device 102 in the embodiments of the present disclosure is also an infrared imaging camera or a night vision device for acquiring image information of dark regions.

The detection device 101 for leftover objects is used for receiving image data from the camera device 102, and detecting whether there are leftover objects in the target region according to the image data.

The left-behind object detection apparatus 101 in the embodiments of the present disclosure is a server, including:
a processor, which is a general-purpose central processing unit (CPU), a microprocessor, an application specific integrated circuit (ASIC), or one or more integrated circuits for controlling execution of programs of solutions of the present disclosure;
a transceiver, which is a device that uses any transceiver to communicate with other devices or communication networks, such as Ethernet, radio access network (RAN), wireless local area networks (WLANs), etc.; and
a memory, which is a read-only memory (ROM) or a static storage device of any other type that can store static information and instructions, a random access memory (RAM), or a dynamic storage device of any other type that can store information and instructions, or an electrically erasable programmable read-only memory (EEPROM), a compact disc read-only memory (CD-ROM) or any other compact disc storage or optical disc storage (including a compact disc, a laser disc, an optical disc, a digital versatile disc or a Blue-ray disc), a magnetic disc storage medium or any other magnetic storage device, or any other medium that can be used to carry or store desired program codes in a form of instructions or data structures and that can be accessed by a computer, but is not limited thereto. The memory may exist independently and be connected to the processor through a communication line. The memory may also be integrated with the processor.

The left-behind object detection apparatus 101 in the embodiments of the present disclosure may also be part of devices coupled to a server, for example, a chip system in the server.

It should be noted that the embodiments of the present disclosure may refer to each other, for example, the same or similar steps, method embodiments, system embodiments and device embodiments may refer to each other without limitation.

In the field of video monitoring, the left-behind object detection can be applied to a variety of scenarios. For example, if the left-behind objects are detected in public regions, it may be possible to discover missing items in time and alert the police, and in turn to avoid property damage of users. As another example, if the object retention is detected in critical regions, it may be possible to discover object obstruction issues in time and alert the police, and in turn to eliminate safety hazards.

Generally, a Gaussian mixture model (GMM) is used to detect foreground objects appearing in a monitoring image. However, this solution detects whether a foreground object appears by detecting whether a pixel value of a pixel in an image changes greatly. When the pixel value in the monitoring screen changes suddenly due to factors such as illumination changes, this solution will determine a pixel with a sudden change in pixel value as a foreground pixel, resulting in low detection accuracy of the foreground objects.

In light of this, the present disclosure provides a method for left-behind object detection.

As shown in FIG. 2, FIG. 2 shows a method for left-behind object detection according to some embodiments, and the method includes the following steps.

In S201, the left-behind object detection apparatus acquires a first to-be-detected image of a target region at a first moment.

The left-behind object detection apparatus is the detection apparatus 101 in FIG. 1, or is a device, such as a chip, of the detection apparatus 101. The target region is a region detected by the left-behind object detection apparatus, and the first to-be-detected image is an image corresponding to the target region.

In a possible implementation manner, the detection apparatus acquires the first to-be-detected image of the target region at the first moment through a camera device. The camera device is the camera device 102 in FIG. 1.

In an example, the left-behind object detection apparatus captures the image of the target region through the camera device, and acquire the first to-be-detected image of the target region at the first moment from the captured image(s).

In another example, the left-behind object detection apparatus periodically captures the image of the target region through the camera device, and acquire the first to-be-detected image of the target region at the first moment from the captured image(s).

In a possible implementation manner, when the image of the target region acquired by the left-behind object detection apparatus at the first moment (e.g., a current moment) has pixel(s) that have changed compared with an image before the first moment, the left-behind object detection apparatus uses the image at the first moment as the first to-be-detected image of the target region.

In S202, the left-behind object detection apparatus determines whether a foreground image exists in the first to-be-detected image according to a foreground image determination model.

The foreground image determination model is used to determine whether a foreground image exists in an image. The foreground image is an image corresponding to a foreground object in the target region.

It should be noted that the foreground image determination model is pre-configured by the left-behind object detection apparatus, or is acquired by the left-behind object detection apparatus from other devices/servers. For example, the foreground image determination model is trained based on a plurality of background images. As for the details of the training process, reference can be made to the following description.

It should be pointed out that the foreground object in the present disclosure refers to a physical substance objectively existing in nature, such as a person, an animal, a plant, a vehicle, a commodity, and the like.

For example, as shown in FIG. 3, a of FIG. 3 is the background image of the target region, and b of FIG. 3 is the first to-be-detected image of the target region. There is a foreground object 30 of b in FIG. 3. The left-behind object detection apparatus determines the foreground image (the image framed by the dotted lines in the figure) corresponding to the foreground object 30 in the first to-be-detected image according to the foreground image determination model.

In a possible implementation manner, the foreground image determination model determines whether there is a foreground image according to the change of a pixel in the first to-be-detected image and a pixel at a corresponding position in the background image.

The pixel is indicated by a pixel value or by a color.

For example, the pixel is indicated by the pixel value, the left-behind object detection apparatus determines the change of a pixel value of each pixel in the first to-be-detected image and a pixel value of a pixel at a corresponding position in the background image according to the foreground image determination model. If there is a pixel whose pixel value has changed in the first to-be-detected image, it is determined that there is a foreground image in the first to-be-detected image. Otherwise, if there is no pixel whose pixel value has changed in the first to-be-detected image, it is determined that there is no foreground image in the first to-be-detected image. The pixel whose pixel value has changed is a foreground pixel.

In a possible implementation manner, the left-behind object detection apparatus determines a range of the foreground image by calculating connected region(s) of the pixel and performing morphological processing. The range of the foreground image is a region occupied by the foreground image in the first to-be-detected image.

For example, the method for calculating the connected region includes a four-connected calculation method and an eight-connected calculation method. The four-connection calculation method refers to connecting foreground pixels in up, down, left and right directions of a location of any foreground pixel as connected pixels to obtain the foreground image.

The morphological processing includes methods such as noise elimination and corrosion operation, and as for detailed processes, reference can be made to related technologies, which are not limited in the present disclosure.

In the case that there is no foreground image in the first to-be-detected image, the left-behind object detection apparatus updates the foreground image determination model.

As for the process of updating the foreground image determination model, reference can be made to the following description, which will not be repeated here.

In S203, in a case where the foreground image exists in the first to-be-detected image and the foreground image satisfies a first preset condition, the left-behind object detection apparatus inputs the foreground image and at least one comparison image into a preset tracking model to obtain at least one tracking result.

The at least one comparison image is an image of the target region within a second time period, and the second time period is a time period after the first moment. The at least one comparison image is a continuous image of the target region within the second time period, or is a discontinuous image within the second time period.

The first preset condition includes one or more restrictive conditions, and the restrictive conditions are used to determine whether to perform tracking detection according to the foreground image. For example, the first preset condition includes at least one of: a ratio of an area of the foreground image to an area of the first to-be-detected image being greater than a first threshold, and the number of pixels in the foreground image being greater than a second threshold. The first threshold is a ratio threshold, and the second threshold is a pixel number threshold. The first threshold and the second threshold can be set according to practical conditions, which is not limited in the present disclosure.

It should be noted that, if there is a foreground image in the first to-be-detected image, then a foreground object corresponding to the foreground image may not be a left-behind object to be detected in the present disclosure. For example, the foreground object is a tiny object such as a fallen leaf. Therefore, the left-behind object detection apparatus can determine whether the foreground image satisfies the first preset condition, and if the first preset condition is satisfied, then track the foreground object in the target region within the time period after the first moment according to the foreground image. In this way, the left-behind object detection apparatus can exclude tiny objects in the target region, thus avoiding detection errors.

In addition, in the case that there are a plurality of foreground images in the first to-be-detected image and the plurality of foreground images satisfy the first preset condition, the left-behind object detection apparatus can separately perform the target tracking on objects corresponding to the plurality of foreground images.

The preset tracking model is used to determine, according to the foreground image, a sub-image with a highest similarity to the foreground image in the comparison image(s) as a tracking image, so as to obtain a corresponding tracking result.

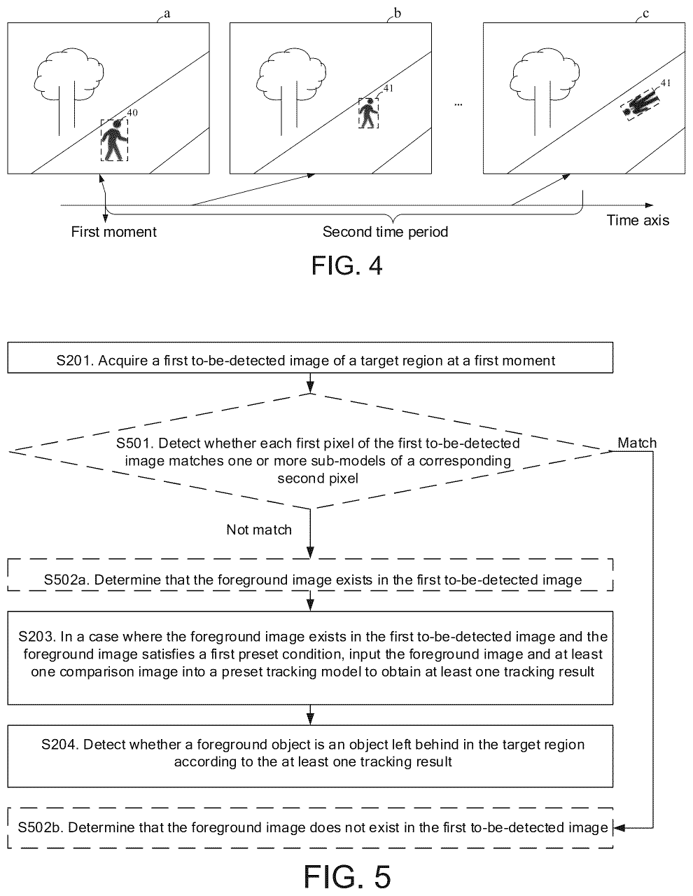

For example, as shown in FIG. 4, a in FIG. 4 is the first to-be-detected image at the first moment, where there is a foreground image 40; and b and c in FIG. 4 are comparison images in the second time period, where there are tracking images 41. The left-behind object detection apparatus inputs the foreground image 40 and b and c of FIG. 4 into the preset tracking model to determine the sub-image with the highest similarity to the foreground image 40 in b and c in FIG. 4 as the tracking image 41, thus obtaining the corresponding tracking result. The tracking result is used to indicate a left-behind condition of the foreground object corresponding to the foreground image 40 in the comparison image.

It should be noted that, in the at least one comparison image in the present disclosure, each comparison image corresponds to one or more tracking results. Therefore, the obtained at least one tracking result includes one or more tracking results corresponding to each comparison image. Each comparison image includes a plurality of sub-images.

The at least one tracking result includes at least one of a first parameter value, a range of a tracking image, or a tracking position. The tracking image is the sub-image with the highest similarity to the foreground image in the comparison image(s), the first parameter value is used to indicate the similarity between the foreground image and the tracking image, the range of the tracking image is a region occupied by the tracking image in the comparison image, and the tracking position is a position of the tracking image in the comparison image.

The region occupied by the tracking image in the comparison image is represented by a proportion of an area of the region occupied by the tracking image in the comparison image, or by the number of pixels in the region occupied by the tracking image in the comparison image.

In the case that the foreground image does not satisfy the first preset condition, the left-behind object detection apparatus updates the foreground image determination model.

As for the process of updating the foreground image determination model, reference can be made to the following description, which will not be repeated here.

In S204, the left-behind object detection apparatus detects whether the foreground object is an object left behind in the target region according to the at least one tracking result.

In a possible implementation manner, the left-behind object detection apparatus determines whether the at least one tracking result satisfies a second preset condition. When the at least one tracking result satisfies the second preset condition, the left-behind object detection apparatus determines that the foreground object is the object left behind in the target region. Otherwise, if any one of the at least one tracking result does not satisfy the second preset condition, the left-behind object detection apparatus determines that the foreground object is not the object left behind in the target region.

The second preset condition includes at least one restrictive condition, and the at least one restrictive condition corresponds to the at least one tracking result. The at least one restrictive condition includes at least one of: the first parameter value being greater than a third threshold, the range of the tracking image being greater than a fourth threshold, or the tracking position being within at least one preset range in the comparison image.

As for the details of the determination process, reference can be made to the following description, which will not be repeated here.

Based on the above technical solutions, the left-behind object detection apparatus in the present disclosure acquires the detection image of the target region at the first moment and preliminarily determines whether there is a foreground image in the image according to the foreground image determination model. If there is a foreground image in the detection image and the foreground image satisfies the first preset condition, it means that the foreground object corresponding to the foreground image is a potential left-behind object required to be detected in the present disclosure. Therefore, the present disclosure also needs to make further determinations through the preset tracking model. The left-behind object detection apparatus obtains the at least one tracking result by inputting the foreground image and the at least one comparison image into the preset tracking model, and detects whether the foreground object is an object left behind in the target region according to the at least one tracking result. Since the at least one comparison image is an image of the target region within the second time period after the first moment, the present disclosure can determine whether the foreground object corresponding to the foreground image stays in the target region for more than a certain length of time, thereby determining whether the foreground object is an object left behind in the target region. Compared with the solution in the related art that performs left-behind object detection only by detecting whether pixel(s) in the image have changed, the present disclosure can avoid the problem of deviation in the foreground object detection caused by sudden changes in the pixel(s) in the region due to factors such as illumination changes, and improve the accuracy of left-behind object detection.

Hereinafter, in conjunction with the above S202, the process of determining, by the left-behind object detection apparatus, whether there is a foreground image in the first to-be-detected image will be introduced in details.

As a possible embodiment of the present disclosure, in conjunction with FIG. 2, as shown in FIG. 5, the above S202 further includes the following S501 to S502b.

In S501, the left-behind object detection apparatus detects whether each first pixel of the first to-be-detected image matches one or more sub-models of a corresponding second pixel.

The foreground image determination model includes one or more sub-models corresponding to a position of each pixel in the background image of the target region. The background image does not include the foreground image. The second pixel is a pixel corresponding to a position of the first pixel in the background image.

The foreground image determination model is a probability distribution model. For example, the probability distribution model includes a Gaussian mixture model and a single-Gaussian model (SGM). Hereinafter, the embodiments of the present disclosure will be described in details by taking an example in which the foreground image determination model is a Gaussian mixture model.

For example, the Gaussian mixture model is the following formula:

$$p ( x ) = {\sum }_{k = 1}^{K} {π}_{k} N ( x \vert {μ}_{k} , {\sum }_{k} ) \\ {\sum }_{k = 1}^{K} {π}_{k} = 1$$

Here, p(x) is the Gaussian mixture model, x is any pixel in the background image of the target region, K is the number of Gaussian distribution models corresponding to the pixel x, πₖ is a weight value of a k^{th} Gaussian distribution model, and N(x|μₖ, Σₖ) is the k^{th} Gaussian distribution model, parameters of the Gaussian distribution model include μₖ and Σₖ, μₖ is a mean value in the k^{th} Gaussian distribution model, and Σₖ is the covariance in the k^{th} Gaussian distribution model. When the pixel is represented by one-dimensional data (for example, the pixel is represented by the pixel value), Σₖ is the variance in the k^{th} Gaussian distribution model. A sum of weight values of the K Gaussian distribution models corresponding to the pixel x is 1.

The left-behind object detection apparatus further determines the one or more sub-models corresponding to the position of each pixel in the background image of the target region according to the weight value of each sub-model.

The K sub-models corresponding to the pixel x are arranged in a descending order based on the weight values, and weight values are sequentially added up so that the sum of the weight values is greater than or equal to the weight threshold and the number of required sub-models is minimized, and one or more sub-models required to sum the weight values are used as the one or more sub-models corresponding to the position of each pixel in the background image of the target region.

Considering an example in which the sub-model is a Gaussian distribution model, the number of one or more sub-models satisfies the following formula:

$$B = arg min ( {\sum }_{b = 1}^{B} {π}_{b} \geq {T}_{0} )$$

Here, B is the number of one or more sub-models, π_{b} is a b^{th} Gaussian distribution model, and T₀ is the weight threshold.

For example, the weight threshold is 0.7, and a pixel 1 corresponds to 5 Gaussian distribution models. A weight value of a first Gaussian distribution model is 0.5, a weight value of a second Gaussian distribution model is 0.2, a weight value of a third Gaussian distribution model is 0.15, a weight value of a fourth Gaussian distribution model is 0.1, and a weight value of a fifth Gaussian distribution model is 0.05.

It is obtained that the sum of the weight value of the first Gaussian distribution model and the weight value of the second Gaussian distribution model is equal to the weight threshold 0.7, and the number of required Gaussian distribution models is minimized, i.e., is 2. Therefore, the left-behind object detection apparatus determines the first Gaussian distribution model and the second Gaussian distribution model as one or more sub-models corresponding to the position of the pixel 1 in the background image of the target region.

In a possible implementation manner, the left-behind object detection apparatus determines a parameter value of any first pixel of the first to-be-detected image and a parameter interval of each sub-model of one or more sub-models of the second pixel corresponding to the first pixel.

When the parameter value of the first pixel is within the parameter interval of the first sub-model, the left-behind object detection apparatus determines that the first pixel matches the first sub-model.

The first sub-model is at least one sub-model in the one or more sub-models of the second pixel corresponding to the first pixel.

In the case where the parameter value of the first pixel is outside the parameter interval of the first sub-model, the left-behind object detection apparatus determines that the first pixel does not match the first sub-model.

The parameter value of the first pixel is represented by a pixel value, a color, or a grayscale value. A parameter interval of a sub-model is determined according to parameters of the sub-model. For example, a lower limit of the parameter interval of the sub-model is a difference between a mean value and a standard deviation of a preset multiple, and an upper limit of the parameter interval is a sum of the mean value and the standard deviation of the preset multiple.

For example, the pixel value of the first pixel is 100, and the second pixel corresponds to 3 sub-models. Each sub-model includes two parameters, i.e., the mean value and the standard deviation. The first sub-model has the mean value of 90 and the standard deviation of 10. The second sub-model has the mean value of 150 and the standard deviation of 15. The third sub-model has the mean value of 200 and the standard deviation of 10. The preset multiple set in the foreground image determination model is 2.5. In this case, the parameter interval corresponding to the first sub-model is [65, 115], the parameter interval corresponding to the second sub-model is [112.5, 187.5], and the parameter interval corresponding to the third sub-model is [175, 225]. Therefore, the first pixel matches the first sub-model, but does not match the second and third sub-models.

In the case where at least one first pixel does not match one or more sub-models of a corresponding second pixel, the at least one first pixel is a foreground pixel, and the left-behind object detection apparatus performs S502a.

For example, the first to-be-detected image includes a first pixel A1 and a first pixel B1. The background image includes a second pixel A2 and a second pixel B2. The first pixel A1 corresponds to the second pixel A2, and the first pixel B1 corresponds to the second pixel B2. The second pixel A2 corresponds to a sub-model X and a sub-model Y. The second pixel B2 corresponds to a sub-model M and a sub-model N.

In the case where the first pixel A1 does not match the sub-model X and the sub-model Y and the first pixel B1 does not match the sub-model M and the sub-model N, there is a foreground image in the first to-be-detected image.

In the case where the first pixel A1 does not match the sub-model X and the sub-model Y and the first pixel B1 matches at least one of the sub-model M and the sub-model N, there is a foreground image in the first to-be-detected image.

In the case where the first pixel A1 matches at least one of the sub-model X and the sub-model Y and the first pixel B1 does not match the sub-model M and the sub-model N, there is a foreground image in the first to-be-detected image.

In the case where all first pixels match sub-models of corresponding second pixels, each first pixel in the first to-be-detected image is a background pixel, and the left-behind object detection apparatus performs S502b.

In combination with the above examples, in the case where the first pixel A1 matches at least one of the sub-model X and the sub-model Y and the first pixel B1 matches at least one of the sub-model M and the sub-model N, there is no foreground image in the first to-be-detected image.

In S502a, the left-behind object detection apparatus determines that the foreground image exists in the first to-be-detected image.

In S502b, the left-behind object detection apparatus determines that the foreground image does not exist in the first to-be-detected image.

Based on the above technical solutions, the foreground image determination model in the embodiments of the present disclosure includes one or more sub-models corresponding to the position of each pixel in the background image of the target region, so that the foreground image determination model can be used to indicate the background image of the target region. The left-behind object detection apparatus determines a matching relationship between each first pixel in the first to-be-detected image and the sub-model(s) included in the foreground image determination model based on the foreground image determination model, and then can determine whether there is a foreground image in the first to-be-detected image.

In a possible implementation manner, the left-behind object detection apparatus further obtains the foreground image determination model by training according to a plurality of background images.

Further, the left-behind object detection apparatus can train the foreground image determination model according to the plurality of background images and a preset algorithm.

Considering an example in which the foreground image determination model is a Gaussian mixture model, the foreground image determination model trained by the left-behind object detection apparatus in the embodiments of the present disclosure will be described in details below.

The left-behind object detection apparatus generates, according to each pixel in the background image, a corresponding Gaussian distribution model, and sets a weight value of the corresponding Gaussian distribution model as an initial weight value (for example, 1/K) until the position of each pixel in the background image corresponds to K Gaussian distribution models. K is a positive integer.

The left-behind object detection apparatus obtains other images in the background image, and for each pixel in the background image, determines whether there is a Gaussian distribution model matching the pixel among the K Gaussian distribution models corresponding to the position of the pixel.

In the case where there is a matched Gaussian distribution model, the weight value of the Gaussian distribution model is increased.

In the case where there is no matched Gaussian distribution model, a new Gaussian distribution model is generated according to the pixel, and a model with the minimum weight value among the original K Gaussian distribution models is replaced with the new Gaussian distribution model.

The mean value of the new Gaussian distribution model is the pixel value of the pixel. The weight value and variance of the new Gaussian distribution model can be set according to practical situations. For example, the weight value is set to the lowest value among the K Gaussian distribution models, and the variance is set to the highest value among the K Gaussian distribution models, which will not be limited in the present disclosure.

In a possible implementation manner, the left-behind object detection apparatus performs data processing on the weight values of the generated K Gaussian distribution models, so that the sum of the weight values of the K Gaussian distribution models is 1.

Hereinafter, in conjunction with the above S203, the process of obtaining, by the left-behind object detection apparatus, the at least one tracking result will be introduced in details.

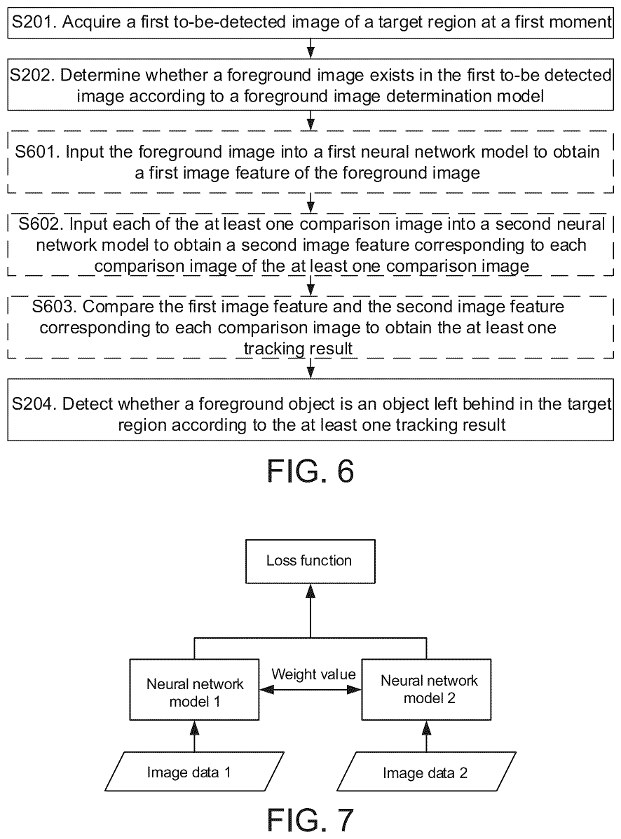

As a possible embodiment of the present disclosure, in conjunction with FIG. 2 or 5, as shown in FIG. 6, the above S203 further includes the following S601 to S603.

In S601, the left-behind object detection apparatus inputs the foreground image into a first neural network model to obtain a first image feature of the foreground image.

The first image feature can indicate image information of the foreground image. For example, the first image feature includes a color feature, a texture feature, a scale feature, etc. of the foreground image. The first image feature is expressed in the form of a feature vector. For example, the first image feature is [0.256314, 0.125647, 0.15248, . . . , 0.1524669].

The preset tracking model includes at least one neural network model. The first neural network model is any one of the at least one neural network model. The any one of the at least one neural network model has a weight value.

When the preset tracking model includes one neural network model, the left-behind object detection apparatus inputs the foreground image into the neural network model to obtain the first image feature of the foreground image.

When the preset tracking model includes a plurality of neural network models, the left-behind object detection apparatus inputs the foreground image into the first neural network model among the plurality of neural network models to obtain the first image feature of the foreground image. The algorithms of the plurality of neural network models are the same algorithm or different algorithms.

In a possible implementation manner, the preset tracking model is a siamese network model. A first neural network model and a second neural network model in the siamese network model are the same neural network model. For example, the siamese network model includes SiamRPN++, SiamRPN, SiamFC, SiamMask, etc. The preset tracking model is also a pseudo siamese network. A first neural network model and a second neural network model in the pseudo siamese network model are different neural network models.

The neural network model is a deep learning network, such as a convolutional neural network (CNN) and a long short term memory network (LSTM).

In S602, the left-behind object detection apparatus inputs each of the at least one comparison image into the second neural network model to obtain a second image feature corresponding to each comparison image of the at least one comparison image.

The second neural network model is any neural network model in the at least one neural network model except the first neural network model. The first neural network model and the second neural network model are the same neural network model, or the first neural network model and the second neural network model are different neural network models, which will be discussed separately below by dividing into situations 1 and 2.

In situation 1, the first neural network model and the second neural network model are the same neural network model. After the left-behind object detection apparatus performs the above S601 to input the foreground image into the neural network model to obtain the first image feature of the foreground image, the left-behind object detection apparatus performs S602 to input each of the at least one comparison image into the neural network model to obtain the second image feature corresponding to each of the at least one comparison image. The left-behind object detection apparatus performs S602 first, and then performs S601. The present disclosure is not limited thereto.

In situation 2, the first neural network model and the second neural network model are different neural network models. The weight values of the first neural network model and the second neural network model are different, or the neural network algorithms of the first neural network model and the second neural network model are different. In this case, the left-behind object detection apparatus may first perform S601 and then perform S602, the left-behind object detection apparatus may first perform S602 and then perform S601, or the left-behind object detection apparatus may also perform S601 and S602 simultaneously in a parallel operation manner, which is not limited in the present disclosure.

In the embodiments of the present disclosure, the weight values of the first neural network model and the second neural network model are obtained according to the image training of the target region, or are obtained according to the training of other image data sets, which is not limited in the present disclosure.

It can be seen from the above two situations that the weight values of the first neural network model and the second neural network model in the embodiments of the present disclosure may be the same. The weight values of the first neural network model and the second neural network model may also be different.

In addition, in the embodiments of the present disclosure, each comparison image of the at least one comparison image input by the left-behind object detection apparatus may be the comparison image itself, or may be a sub-image corresponding to the position of the foreground image in the comparison image.

The sub-image corresponding to the position of the foreground image in the comparison image is an image with the same size as the foreground image, or an image with a different size than the foreground image.

For example, an area of the sub-image corresponding to the position of the foreground image in the comparison image is 2.5 times the area of the foreground image.

It should be noted that the at least one comparison image includes first comparison image(s), and the first comparison image(s) are comparison image(s) within a preset time period in the second time period. The preset time period is the second time period, or a part of the second time period.

The left-behind object detection apparatus inputs each of the first comparison image(s) into the second neural network model to obtain a second image feature corresponding to each comparison image of the first comparison image(s).

In S603, the left-behind object detection apparatus compares the first image feature and the second image feature corresponding to each comparison image to obtain the at least one tracking result.

The at least one tracking result includes at least one of a first parameter value, a range of a tracking image, or a tracking position. The preset tracking model further includes a preset loss function.

In a possible implementation manner, the left-behind object detection apparatus inputs the first image feature and the second image feature corresponding to each comparison image into the preset loss function to obtain the at least one tracking result.

For example, the at least one comparison image includes a comparison image 1, a comparison image 2, and a comparison image 3. The comparison image 1 corresponds to a second image feature 1, the comparison image 2 corresponds to a second image feature 2, and the comparison image 3 corresponds to a second image feature 3. The left-behind object detection apparatus compares the first image feature and the second image feature 1 to obtain a tracking result 1 and a tracking result 2 corresponding to the comparison image 1. The left-behind object detection apparatus compares the first image feature and the second image feature 2 to obtain a tracking result 3, a tracking result 4 and a tracking result 5 corresponding to the comparison image 2. The left-behind object detection apparatus compares the first image feature and the second image feature 3 to obtain a tracking result 6 corresponding to the comparison image 3.

Based on the above technical solutions, the left-behind object detection apparatus in the embodiments of the present disclosure inputs the foreground image into the first neural network model to obtain the first image feature, and input each of the at least one comparison image into the second neural network model to obtain the second image feature, and in turn obtain the at least one tracking result according to the first image feature and the second image feature. In this way, the left-behind object detection apparatus tracks the foreground object corresponding to the foreground image in the comparison image based on the at least one tracking result, and then determines whether there is a left-behind object in the target region, thus improving the accuracy of the left-behind object detection.

Considering an example in which the preset tracking model is a siamese network model, the method for left-behind object detection involved in the embodiments of the present disclosure will be described in details below. As shown in FIG. 7, the siamese network model includes a neural network model 1, a neural network model 2 and a loss function. The weight values of the neural network model 1 and the neural network model 2 are the same.

The left-behind object detection apparatus inputs the foreground image as a template image into the neural network model 1 to obtain the first image feature of the foreground image. The left-behind object detection apparatus inputs each of the at least one comparison image as a search regression image into the neural network model 2 to obtain the second image feature corresponding to each of the at least one comparison image. The left-behind object detection apparatus inputs the obtained first image feature and second image feature into the loss function to obtain the at least one tracking result.

Hereinafter, in conjunction with the above S204, the process of obtaining, by the left-behind object detection apparatus, the at least one tracking result will be introduced in details.

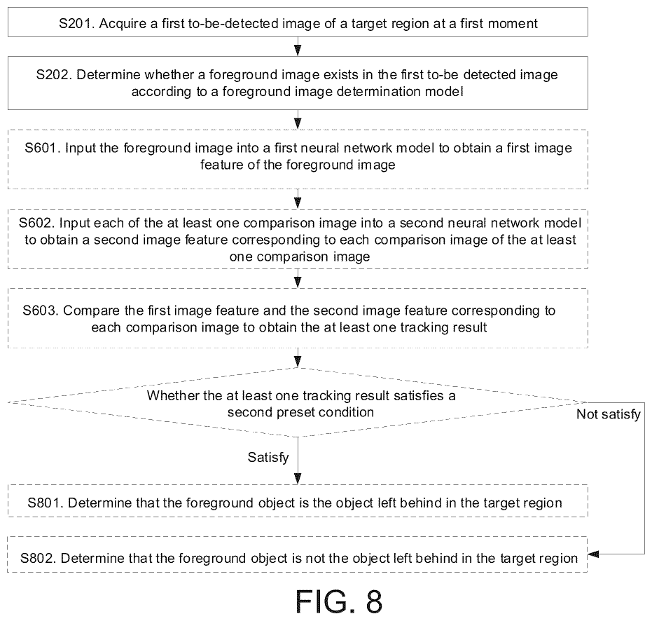

As a possible embodiment of the present disclosure, in conjunction with FIG. 6, as shown in FIG. 8, the above S204 further includes the following S801 and S802.

In S801, in the case where the at least one tracking result satisfies the second preset condition, the left-behind object detection apparatus determines that the foreground object is an object left behind in the target region.

The second preset condition includes at least one restrictive condition, and the at least one restrictive condition corresponds to the at least one tracking result.

The at least one restrictive condition includes at least one of: the first parameter value being greater than a third threshold, the range of the tracking image being greater than a fourth threshold, or the tracking position being within at least one preset range in the comparison image. The third threshold is a similarity threshold between the foreground image and the tracking image, and the fourth threshold is a range threshold of the tracking image.

The above S801 is implemented as follows: in the case where the first parameter value is greater than the third threshold, and/or the range of the tracking image is greater than the fourth threshold, and/or the tracking position is within the at least one preset range in the comparison image, the left-behind object detection apparatus determines that the foreground object is an object left behind in the target region.

It should be noted that, in the embodiments of the present disclosure, the first parameter value is used to indicate the similarity between the foreground image and the corresponding tracking image in the comparison image. The higher the first parameter value, the higher the similarity between the foreground image and the tracking image. Therefore, when the first parameter value is greater than the third threshold, the left-behind object detection apparatus determines that the object corresponding to the tracking image is the foreground object corresponding to the foreground image.

The range of the tracking image in the embodiments of the present disclosure is the ratio of the area of the tracking image to the area of the comparison image or the number of pixels of the tracking image, and is used to indicate the size of the object corresponding to the tracking image. Therefore, by determining whether the range of the tracking image is greater than the fourth threshold, the left-behind object detection apparatus can determine the change in size of the object corresponding to the tracking image, and in turn determine whether the object will affect the target region.

For example, the object is an inflated balloon, and after the left-behind object detection apparatus detects the foreground image corresponding to the inflated balloon, the inflated balloon is gradually deflated (that is, the area of the foreground image gradually decreases). At this time, the deflated balloon cannot have a large impact on the target region, and the left-behind object detection apparatus determines the range of the tracking image based on the deflated balloon in the comparison image, and then determine that the range of the tracking image does not satisfy the second preset condition.

The left-behind object detection apparatus in the embodiments of the present disclosure further sets at least one preset range in the target region, and then determines whether the tracking position of the tracking image is within the at least one preset range in the comparison image, thereby realizing the targeted detection of the critical region in the target region.

In S802, in the case where any one of the at least one tracking result does not satisfy the second preset condition, the left-behind object detection apparatus determines that the foreground object is not an object left behind in the target region.

As for the determination process, reference can be made to the above S801, and details will not be repeated here.

Based on the above technical solutions, the left-behind object detection apparatus in the embodiments of the present disclosure can detect whether the foreground object is an object left behind in the target region by determining whether the at least one tracking result satisfies the second preset condition. The at least one tracking result includes at least one of the first parameter value, the range of the tracking image or the tracking position. The first parameter value can indicate the similarity between the foreground image and the tracking image, and the range of tracking the image can indicate the change in size of the object corresponding to the tracking image, and the tracking position can indicate the positional movement of the object corresponding to the tracking image. Therefore, the left-behind object detection apparatus can detect the left-behind situation of the foreground object based on at least one factor of the similarity, change in size, or positional movement of the tracking image, which improves the accuracy of left-behind object detection.

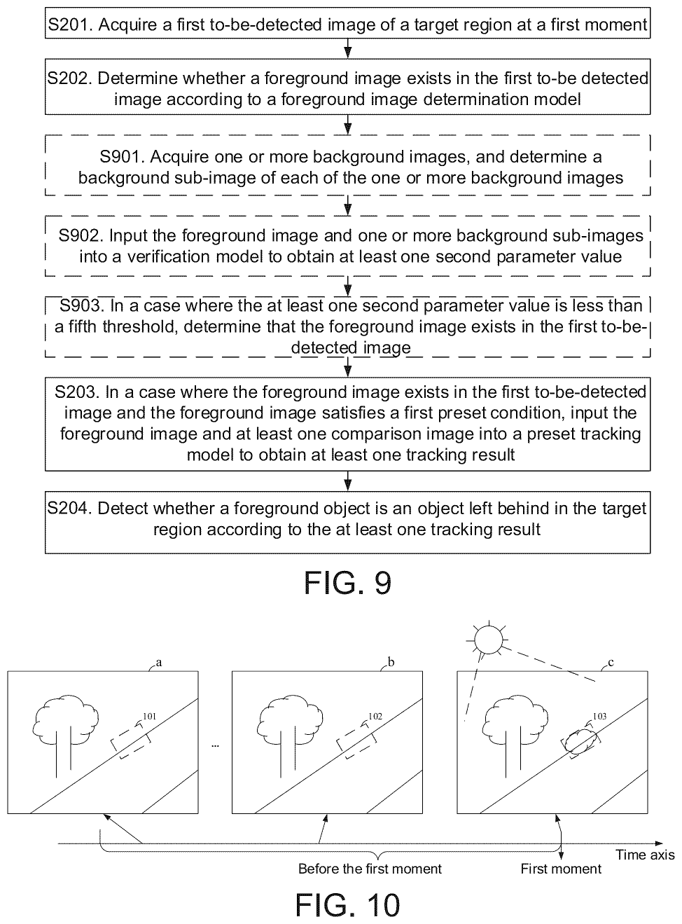

As a possible embodiment of the present disclosure, in conjunction with FIG. 2, as shown in FIG. 9, before S203, the method further includes the following S901 to S903.

In S901, the left-behind object detection apparatus acquires one or more background images, and determines a background sub-image of each background image of the one or more background images.

A position of the background sub-image in the background image corresponds to the position of the foreground image in the first to-be-detected image. A range of the background sub-image may be the same as the range of the foreground image. The range of the background sub-image may also be different from the range of the foreground image. The range of the background sub-image is an area occupied by the background sub-image in the background image.

It should be noted that the one or more background images acquired by the left-behind object detection apparatus are images of the target region before the first moment. That is, the left-behind object detection apparatus determines that image(s) of the target region before the foreground image exists in the first to-be-detected image.

Therefore, the one or more background images are images without a foreground image or images not satisfying the first preset condition, which are determined by the left-behind object detection apparatus according to the foreground image determination model.

In S902, the left-behind object detection apparatus inputs the foreground image and one or more background sub-images into a verification model to obtain at least one second parameter value.

The verification model is used to calculate the similarity between the foreground image and the one or more background sub-images. The second parameter value is used to indicate the similarity between the foreground image and the background sub-image. The at least one second parameter value is a second parameter value of the one or more background sub-images.

It should be noted that an algorithm of the verification model in the embodiments of the present disclosure is different from the algorithm of the above-mentioned foreground image determination model. For example, the verification model is the preset tracking model as mentioned in the above method, or other models used to calculate image similarity.

If the verification model is the preset tracking model as mentioned in the above method, as for the process of obtaining the at least one second parameter value for the left-behind object, reference can be made to the process of obtaining the first parameter value for the left-behind object according to the foreground image and the comparison image in the above method, and details will not be repeated here.

In S903, in the case where the at least one second parameter value is less than a fifth threshold, the left-behind object detection apparatus determines that the foreground image exists in the first to-be-detected image.

The fifth threshold is a similarity threshold between the foreground image and the background sub-image, which can be set according to practical conditions and is not limited in the present disclosure.

It should be noted that the background sub-image is a sub-image in the background image of the target region before the first moment. Therefore, in the case where the at least one second parameter value is less than the fifth threshold, it means that before the foreground image determination model determines that there is a foreground image in the first to-be-detected image, the similarity between the background sub-image of the background image in the target region and the foreground image is low, that is, the background sub-image is different from the foreground image. That is to say, the object corresponding to the foreground image determined by the left-behind object detection apparatus according to the foreground image determination model does not appear at the corresponding position of the target region before the first moment. Otherwise, if the at least one second parameter value is greater than or equal to the fifth threshold, it means that the object corresponding to the foreground image determined by the left-behind object detection apparatus according to the foreground image determination model has been located at the corresponding position of the target region before the first moment.

The at least one second parameter value is less than the fifth threshold, which means that any one of the at least one second parameter value is less than the fifth threshold, or a mean value of the at least one second parameter value is less than the fifth threshold.

For example, as shown in FIG. 10, a and b in FIG. 10 are background images of the target region before the first moment, and c in FIG. 10 is the first to-be-detected image at the first moment. Due to the illumination factor, the left-behind object detection apparatus determines that the foreground image 103 exists in the first to-be-detected image according to the foreground image determination model. The left-behind object detection apparatus obtains a and b in FIG. 10, and determines the background sub-image 101 in a in FIG. 10 and the background sub-image 102 in b in FIG. 10. The left-behind object detection apparatus inputs the foreground image 103, the background sub-image 101 and the background sub-image 102 into the verification model, and obtains the second parameter value 1 corresponding to the background sub-image 101 and the second parameter value 2 corresponding to the background sub-image 102. The second parameter value 1 is 0.7, the second parameter value 2 is 0.8, and the fifth threshold is 0.5. Since there is a parameter value greater than or equal to the fifth threshold in the second parameter value 1 and the second parameter value 2, the similarity between the foreground image and the sub-image at the corresponding position before the first moment is high, and the left-behind object detection apparatus determines that there is no foreground image in the first to-be-detected image.

Otherwise, the left-behind object detection apparatus determines that there is a foreground image in the first to-be-detected image, and details of the process will not be repeated here.

Based on the above technical solutions, before tracking the foreground object according to the foreground image and the at least one comparison image, the left-behind object detection apparatus in the embodiments of the present disclosure can further verify, through the verification model according to the foreground image and the at least one background sub-image before the first moment, the foreground image determined by the foreground image determination model, to determine whether the foreground image has appeared before the first moment. If the similarity between the foreground image and the at least one background sub-image before the first moment is low, it means that the foreground image did not appear before the first moment, that is, there is a foreground image in the first to-be-detected image. Otherwise, it means that the foreground image has appeared before the first moment, that is, there is no foreground image in the first to-be-detected image. In this way, before performing the target tracking operation, the left-behind object detection apparatus can verify, through the verification model, whether the foreground image determined by the foreground image determination model is accurate, thereby improving the detection efficiency and accuracy of the left-behind object detection.

As a possible embodiment of the present disclosure, after S204 of detecting, by the left-behind object detection apparatus, whether the foreground object is an object left behind in the target region, the method further includes as follows.

In the case that the foreground object is an object left behind in the target region, the left-behind object detection apparatus outputs prompt information.

The prompt information is used to prompt that there is a left-behind object in the target region. The prompt information is text prompt information, voice prompt information, or image prompt information.

Hereinafter, in combination with the above-mentioned embodiments, in the case where there is no foreground image in the first to-be-detected image, or the foreground image does not satisfy the first preset condition, or the foreground object is not an object left behind in the target region, the left-behind object detection apparatus updates the foreground image determination model.

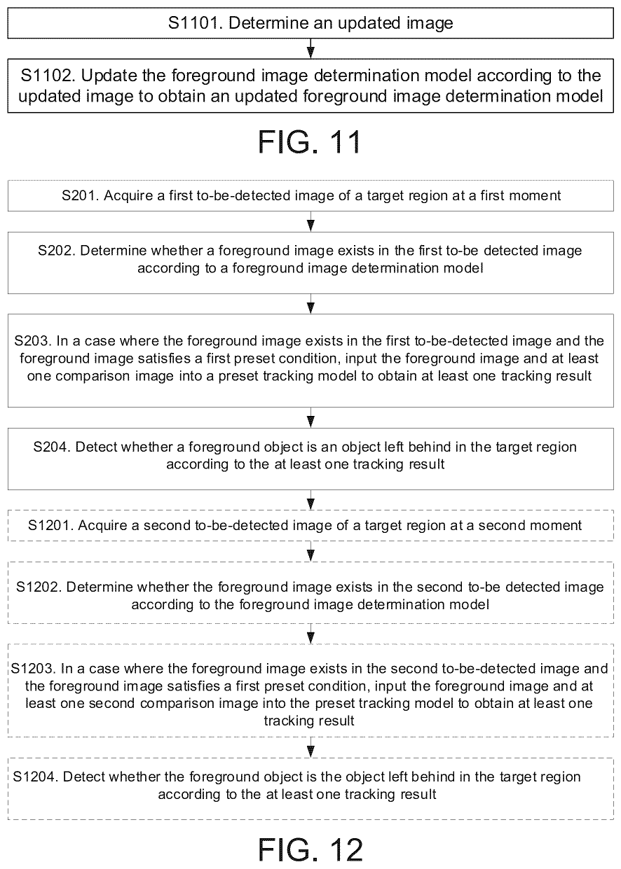

As a possible embodiment of the present disclosure, as shown in FIG. 11, the method of updating, by the left-behind object detection apparatus, the foreground image determination model includes as follows.

In S1101, the left-behind object detection apparatus determines an updated image.

The updated image is the first to-be-detected image.

It should be noted that, in the case where the foreground image does not satisfy the first preset condition, or the foreground object is not an object left behind in the target region, the updated image is the first to-be-detected image, or an image of the target region at a current moment.

In S1102, the left-behind object detection apparatus updates the foreground image determination model according to the updated image to obtain an updated foreground image determination model.

The updated foreground image determination model can be used to determine whether there is a foreground image in an image.

In a possible implementation manner, the left-behind object detection apparatus further obtains the updated foreground image determination model by re-training according to a preset algorithm and the updated image. As for the training process, reference can be made to the above-mentioned training process of the model, and details will not be repeated here.

In yet another possible implementation manner, the left-behind object detection apparatus updates, based on a foreground image determination model before updating, sub-model(s) in the foreground image determination model before updating according to the updated image, so as to obtain the updated foreground image determination model. The detailed processes of this implementation are as follows.
1. For each third pixel in the updated image, the left-behind object detection apparatus detects whether there is a sub-model matching the third pixel among one or more sub-models corresponding to the second pixel.

The foreground image determination model includes one or more sub-models corresponding to the position of each pixel in the background image of the target region, each sub-model corresponds to a weight value, and the second pixel is a pixel corresponding to a position of the third pixel in the background image.

As for the method of detecting whether the third pixel matches the sub-model, reference can be made to the above related description of S501, which will not be repeated here.
2. If there is a second sub-model in the one or more sub-models, the left-behind object detection apparatus increases a weight value of the second sub-model, and decreases a weight value of a third sub-model.

The second sub-model is a sub-model matching the third pixel among the one or more sub-models, and the third sub-model is another sub-model except the second sub-model among the one or more sub-models. Among the one or more sub-models corresponding to the second pixel, there is one sub-model matching the third pixel, or there are a plurality of sub-models matching the third pixel.

It should be noted that the higher the weight value of the sub-model, the greater the proportion of the sub-model in the one or more sub-models. Therefore, when there is a second sub-model matching the third pixel among the one or more sub-models, it may be possible to increase the weight value of the second sub-model and decrease the weight value of the third sub-model, and in turn to increase the proportion of the second sub-model.

The left-behind object detection apparatus obtains the updated foreground image determination model according to the increased weight value of the second sub-model and the decreased weight value of the third sub-model.

The updated foreground image determination model includes a second sub-model with an increased weight value corresponding to each third pixel in the updated image and a third sub-model with a decreased weight value.
3. In the case that there is no second sub-model in the one or more sub-models, the left-behind object detection apparatus generates a fourth sub-model according to the third pixel, and replaces a sub-model with the minimum weight value among the one or more sub-models with the fourth sub-model, so as to obtain the updated foreground image determination model.

It should be noted that when there is no second sub-model in the one or more sub-models, it means that the third pixel is determined as a foreground pixel in the foreground image determination model. Therefore, the left-behind object detection apparatus generates the fourth sub-model according to the third pixel, and replaces the sub-model with the minimum weight value among the one or more sub-models with the fourth sub-model, so that the updated foreground image determination model can determine that the third pixel is a background pixel.

Based on the above technical solutions, when there is no foreground image in the first to-be-detected image, or the foreground image does not satisfy the first preset condition, or the foreground object is not an object left behind in the target region, the left-behind object detection apparatus updates the foreground image determination model according to the updated image(s) to obtain the updated foreground image determination model, thereby avoiding the problem that the foreground image detects other pixels in the target region except the foreground pixel(s) corresponding to the left-behind object as foreground pixels, and improving the accuracy of left-behind object detection.

As a possible embodiment of the present disclosure, the method provided in the embodiments of the present disclosure includes: re-detecting, by the left-behind object detection apparatus, whether there is a left-behind object in the target region.

As shown in FIG. 12, the process of re-detecting, by the left-behind object detection apparatus, whether there is a left-behind object in the target region includes S1201 to S1204.

In S1201, the left-behind object detection apparatus acquires a second to-be-detected image of the target region at a second moment.

The second moment is a moment after the first moment. As for details, reference can be made to the related description of S201, which will not be repeated here.

In S1202, the left-behind object detection apparatus determines whether the foreground image exists in the second to-be-detected image according to the foreground image determination model.

The foreground image determining model is a foreground image determining model before updating, or is a foreground image determining model after updating.

As for details, reference can be made to the related description of S202, which will not be repeated here.

In S1203, in the case that the foreground image exists in the second to-be-detected image and the foreground image satisfies a first preset condition, the left-behind object detection apparatus inputs the foreground image and at least one second comparison image into the preset tracking model to obtain at least one tracking result.

As for details, reference can be made to the related description of S203, which will not be repeated here.

In S1204, the left-behind object detection apparatus detects whether the foreground object is an object left behind in the target region according to the at least one tracking result.

As for details, reference can be made to the related description of S204, which will not be repeated here.

Based on the above technical solutions, the left-behind object detection apparatus can dynamically detect whether there is a left-behind object in the target region, and the detection method is flexible and convenient.

In the embodiments of the present disclosure, the left-behind object detection apparatus is divided into functional modules or units according to the foregoing method examples. For example, the terminal may be divided in a way that each functional module or unit corresponds to a function, or that two or more functions are integrated into one processing module. The integrated module may be implemented in a form of hardware or in a form of software functional module or unit. The division of modules or units in the embodiments of the present disclosure is schematic, which is merely a logical function division, and there may be other division manners in actual implementation.

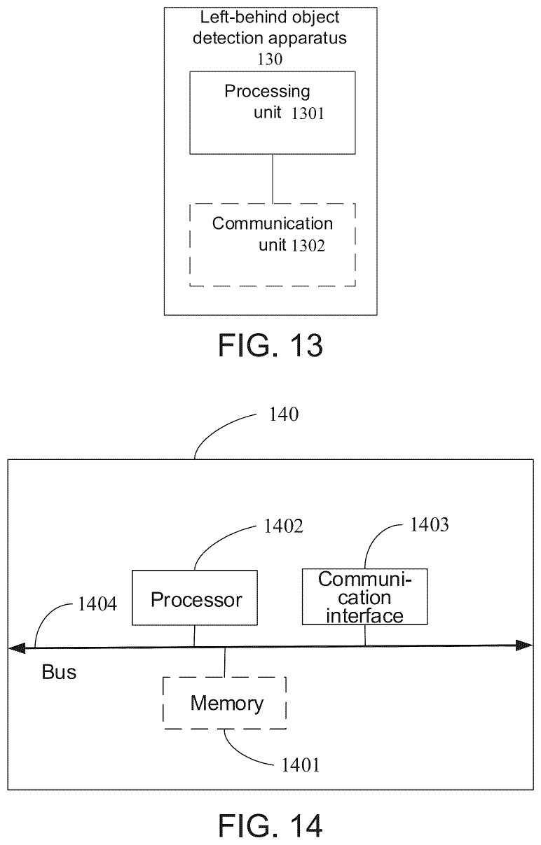

As shown in FIG. 13, which is a schematic structural diagram of a left-behind object detection apparatus 130 according to some embodiments, the apparatus includes as follows.

A processing unit 1301 is configured to acquire a first to-be-detected image of a target region at a first moment.

The left-behind object detection apparatus 130 further includes a communication unit 1302.

The left-behind object detection apparatus 130 receives the first to-be-detected image of the target region in real time through the communication unit 1302, and obtains the first to-be-detected image of the target region at the first moment from the received image through the processing unit 1301.

The left-behind object detection apparatus 130 also regularly receives the first to-be-detected image of the target region through the communication unit 1302, and obtains the first to-be-detected image of the target region at the first moment from the received image through the processing unit 1301.

The processing unit 1301 is further configured to determine whether a foreground image exists in the first to-be-detected image according to a foreground image determination model.

The foreground image is an image corresponding to a foreground object in the target region, and the foreground image determination model is used to determine whether there is a foreground image in the image.

In the case where the foreground image exists in the first to-be-detected image and the foreground image satisfies the first preset condition, the processing unit 1301 is further configured to input the foreground image and at least one comparison image into a preset tracking model to obtain at least one tracking result.

The at least one comparison image is an image of the target region within a second time period, and the second time period is a time period after the first moment; and the first preset condition includes at least one of: a ratio of an area of the foreground image to an area of the first to-be-detected image being greater than a first threshold, or the number of pixels of the foreground image being greater than a second threshold.

The processing unit 1301 is further configured to detect whether the foreground object is an object left behind in the target region according to the at least one tracking result.

In some embodiments, the foreground image determination model includes one or more sub-models corresponding to a position of each pixel in a background image of the target region, and the background image does not include the foreground image; the processing unit 1301 is configured to: detect whether each first pixel of the first to-be-detected image matches one or more sub-models of a corresponding second pixel, the second pixel being a pixel corresponding to a position of the first pixel in the background image; in the case where at least one first pixel does not match one or more sub-models of a corresponding second pixel, determine that the foreground image exists in the first to-be-detected image; and in the case where all first pixels match sub-models of corresponding second pixels, determine that the foreground image does not exist in the first to-be-detected image.

In some embodiments, the processing unit 1301 is configured to: determine a parameter value of any first pixel of the first to-be-detected image and a parameter interval of each sub-model of one or more sub-models of the second pixel corresponding to the first pixel; in the case where the parameter value of the first pixel is within a parameter interval of a first sub-model, determine that the first pixel matches the first sub-model, the first sub-model being at least one sub-model of the one or more sub-models of the second pixel corresponding to the first pixel; and in the case where the parameter value of the first pixel is outside the parameter interval of the first sub-model, determine that the first pixel does not match the first sub-model.

In some embodiments, the preset tracking model includes at least one neural network model; the processing unit 1301 is configured to: input the foreground image into a first neural network model to obtain a first image feature of the foreground image, the first neural network model being any neural network model of the at least one neural network model; input each of at least one comparison image into a second neural network model to obtain a second image feature corresponding to each comparison image of the at least one comparison image, the second neural network model being any neural network model except the first neural network in the at least one neural network model; and compare the first image feature with the second image feature corresponding to each comparison image to obtain at least one tracking result.

In some embodiments, the at least one tracking result includes at least one of: a first parameter value, a range of a tracking image, or a tracking position. The tracking image is a sub-image with the highest similarity to the foreground image in the comparison image, and the first parameter value is used to indicate the similarity between the foreground image and the tracking image, the range of the tracking image is a region occupied by the tracking image in the comparison image, and the tracking position is a position of the tracking image in the comparison image.

In some embodiments, the processing unit 1301 is configured to: in the case where the at least one tracking result satisfies a second preset condition, determine that the foreground object is an object left behind in the target region, the second preset condition including at least one restrictive condition that corresponds to the at least one tracking result; and in the case where any of the at least one tracking result does not satisfy the second preset condition, determine that the foreground object is not an object left behind in the target region.

In some embodiments, the processing unit 1301 is configured to: in the case where the first parameter value is greater than a third threshold, and/or the range of the tracking image is greater than a fourth threshold, and/or the tracking position is within at least one preset range in the comparison image, determine that the foreground object is an object left behind in the target region.

In some embodiments, the processing unit 1301 is further configured to: acquire one or more background images, and determine a background sub-image of each background image in the one or more background images, a position of the background sub-image in the background image corresponding to the position of the foreground image in the first to-be-detected image; input the foreground image and the one or more background sub-images into a verification model to obtain at least one second parameter value, the second parameter value being used to indicate the similarity between the foreground image and the background sub-image; and in the case where the at least one second parameter value is less than a fifth threshold, determine that the foreground image exists in the first to-be-detected image.

In some embodiments, in the case where the foreground image does not exist in the first to-be-detected image, or the foreground image does not satisfy the first preset condition, or the foreground object is not an object left behind in the target region, the processing unit 1301 is further configured to update the foreground image determination model.

In some embodiments, the processing unit 1301 is configured to: determine an updated image, the updated image being the first to-be-detected image; and update the foreground image determination model according to the updated image.

In some embodiments, the foreground image determination model includes one or more sub-models corresponding to a position of each pixel in the background image of the target region, and each sub-model corresponds to a weight value. The processing unit 1301 is configured to: for each third pixel in the updated image, detect whether a sub-model matching the third pixel exists in the one or more sub-models corresponding to the second pixel, the second pixel being a pixel corresponding to a position of the third pixel in the background image; in the case where the second sub-model exists in the one or more sub-models, increase a weight value of the second sub-model and decrease a weight value of the third sub-model, the second sub-model being a sub-model matching the third pixel in the one or more sub-models, the third sub-model being another sub-model except the second sub-model in the one or more sub-models; and update the foreground image determination model according to the increased weight value of the second sub-model and the decreased weight value of the third sub-model.

In some embodiments, the processing unit 1301 is configured to: in the case where the second sub-model does not exist in the one or more sub-models, generate a fourth sub-model according to the third pixel, and replace a sub-model with the minimum weight value in the one or more sub-models with the fourth sub-model to obtain the updated foreground image determination model.

In some embodiments, the processing unit 1301 is configured to: acquire a second to-be-detected image of the target region at a second moment, the second moment being a moment after the first moment; determine where the foreground image exists in the second to-be-detected image according to the foreground image determination model; in the case where the foreground image exists in the second to-be-detected image and the foreground image satisfies a first preset condition, input the foreground image and at least one second comparison image into the preset tracking model to obtain at least one tracking result, the at least one second comparison image being an image of the target region within a third time period, the third time period being a time period after the second moment, and the first preset condition including at least one of a ratio of an area of the foreground image to an area of the second to-be-detected image being greater than the first threshold and the number of pixels of the foreground image being greater than the second threshold; and detect whether the foreground object is an object left behind in the target region according to the at least one tracking result.

In some embodiments, the communication unit 1302 is configured to output prompt information in the case where the foreground object is an object left behind in the target region.

When implemented by hardware, the communication unit 1302 in the embodiments of the present disclosure can be integrated in a communication interface, and the processing unit 1301 can be integrated in a processor. The details of the implementation are shown in FIG. 14.

FIG. 14 shows a possible structural schematic diagram of another left-behind object detection apparatus involved in the above embodiments. The left-behind object detection apparatus 140 includes: a processor 1402 and a communication interface 1403. The processor 1402 is configured to control and manage the actions of the left-behind object detection apparatus 140, e.g., to execute the steps executed by the above processing unit 1301, and/or configured to execute other processes of the technologies described herein. The communication interface 1403 is configured to support the communication between the left-behind object detection apparatus 140 and other network entities, for example, to execute the steps performed by the above communication unit 1302. The left-behind object detection apparatus 140 further includes a memory 1401 and a bus 1404, and the memory 1401 is configured to store program codes and data of the left-behind object detection apparatus 140.

The memory 1401 may be a memory, etc. in the left-behind object detection apparatus 140. The memory may include a volatile memory, e.g., a random access memory; the memory may also include a nonvolatile memory, e.g., a read-only memory, a flash memory, a hard disk or a solid state disk; and the memory may also include a combination of the above-mentioned types of memory.

The above processor 1402 can implement or execute various illustrative logical blocks, modules and circuits described in content of the present disclosure. The processor may be a central processing unit (CPU), a general-purpose processor, a digital signal processor (DSP), an application specific integrated circuit (ASIC), a field programmable gate array (FPGA) or any other programmable logic device, a transistor logic device, a discrete hardware component or any combination thereof. It may implement or execute various illustrative logical blocks, modules and circuits described in content of the present disclosure. The processor may also be a combination that implements computing functions, for example, a combination including one or more microprocessors, a combination of a DSP and a microprocessor, or the like.

The bus 1404 may be an extended industry standard architecture (EISA) bus or the like. The bus 1404 may be divided into an address bus, a data bus, a control bus, etc. For the convenience of representation, only one thick line is used in FIG. 14 for representation, but it does not mean that there is only one bus or one type of bus.

The left-behind object detection apparatus 140 in FIG. 14 may also be a chip. The chip includes one or more than two (including two) processors 1402 and a communication interface 1403.

Optionally, the chip further includes a memory 1401. The memory 1401 includes a read-only memory and a random access memory, and provides operation instructions and data to the processor 1402. A part of the memory 1401 may also include a nonvolatile random access memory (NVRAM).

In some implementations, the memory 1401 stores the following elements: execution modules or data structures, or their subsets, or their extended sets.

In the embodiments of the present disclosure, the operation instructions stored in the memory 1401 (the operation instructions may be stored in the operating system) are called to execute corresponding operations.

From description of the above embodiments, those skilled in the art will clearly understand that, for convenience and brevity of description, an example is only given according to the above division of functional modules. In practical applications, the above functions may be allocated to different functional modules as needed. That is, an internal structure of the display apparatus is divided into different functional modules to perform all or part of the functions described above. As for the working processes of the above-described system, apparatus, and unit, reference may be made to the corresponding processes in the above method embodiments, and details will not be repeated here.

Some embodiments of the present disclosure provide a computer-readable storage medium (for example, a non-transitory computer-readable storage medium), the computer-readable storage medium has stored thereon computer program instructions, and the computer program instructions, when executed by a computer (for example, a left-behind object detection apparatus), cause the computer to perform the method for left-behind object detection as described in any of the above embodiments.

For example, the computer-readable storage medium may include, but is not limited to a magnetic storage device (e.g., a hard disk, a floppy disk or a magnetic tape), an optical disk (e.g., a compact disk (CD) or a digital versatile disk (DVD)), a smart card and a flash memory device (e.g., an erasable programmable read-only memory (EPROM), a card, a stick or a key driver). Various computer-readable storage media described in the present disclosure may represent one or more devices and/or other machine-readable storage media for storing information. The term “machine-readable storage medium” may include, but is not limited to, wireless channels and various other media capable of storing, containing and/or carrying instructions and/or data.

Some embodiments of the present disclosure provide a computer program product, which is stored on, for example, a non-transitory computer-readable storage medium. The computer program product includes computer program instructions, and when the computer program instructions are executed by a computer (for example, a left-behind object detection apparatus), the computer program instructions cause the computer to perform the method for left-behind object detection as described in the above embodiments.

Some embodiments of the present disclosure further provide a computer program. When executed by a computer (e.g., a left-behind object detection apparatus), the computer program causes the computer to perform the method for left-behind object detection as described in the above embodiments.

Beneficial effects of the computer-readable storage medium, computer program product and computer program described above are the same as the beneficial effects of the method for left-behind object detection described in some of the above embodiments, which will not be repeated here.

In some embodiments provided by the present disclosure, it will be understood that the system, apparatus and method can be implemented in other ways. For example, the embodiments of the apparatus described above are merely exemplary. For example, the division of the units is only a logical functional division. In actual implementation, there may be another division manners. For example, a plurality of units or components are combined or integrated into another system, or some features may be ignored or not executed. In addition, mutual coupling or direct coupling or communication connection shown or discussed above may be indirect coupling or communication connection between the apparatus and units through some interfaces, or may be connections are electrical, mechanical or in other forms.

The units described as separate components may or may not be physically separated; and the components used as units may or may not be physical units, that is, they may be located in one place, or may be distributed to multiple network units. Some or all of the units may be selected according to practical needs to achieve the purposes of the solutions of the embodiments.

In addition, the functional units in the embodiments of the present disclosure may be integrated into one processing unit or may be separate physical units, or two or more units may be integrated into one unit.

The foregoing descriptions are merely specific implementation manners of the present disclosure, but the protection scope of the present disclosure is not limited thereto, any changes or replacements that a person skilled in the art could conceive of within the technical scope of the present disclosure shall be included in the protection scope of the present disclosure. Therefore, the protection scope of the present disclosure shall be subject to the protection scope of the claims.

1. A method for left-behind object detection, comprising:
acquiring a first to-be-detected image of a target region at a first moment;
determining whether a foreground image exists in the first to-be-detected image according to a foreground image determination model, the foreground image being an image corresponding to a foreground object in the target region;
in a case where the foreground image exists in the first to-be-detected image and the foreground image satisfies a first preset condition, inputting the foreground image and at least one comparison image into a preset tracking model to obtain at least one tracking result, wherein the at least one comparison image is an image of the target region within a second time period, the second time period is a time period after the first moment, and the first preset condition includes at least one of: a ratio of an area of the foreground image to an area of the first to-be-detected image being greater than a first threshold, and a number of pixels of the foreground image being greater than a second threshold; and
detecting whether the foreground object is an object left behind in the target region according to the at least one tracking result.

2. The method according to claim 1, wherein the foreground image determination model includes one or more sub-models corresponding to a position of each pixel in a background image of the target region, and the background image does not include the foreground image; and the determining whether a foreground image exists in the first to-be-detected image according to a foreground image determination model includes:
detecting whether each first pixel of the first to-be-detected image matches one or more sub-models of a corresponding second pixel, the second pixel being a pixel corresponding to a position of the first pixel in the background image;
in a case where at least one first pixel does not match one or more sub-models of a corresponding second pixel, determining that the foreground image exists in the first to-be-detected image; and
in a case where all first pixels match sub-models of corresponding second pixels, determining that the foreground image does not exist in the first to-be-detected image.

3. The method according to claim 2, wherein the detecting whether each first pixel of the first to-be-detected image matches one or more sub-models of a corresponding second pixel includes:
determining a parameter value of any first pixel of the first to-be-detected image and a parameter interval of each sub-model of one or more sub-models of a second pixel corresponding to the first pixel;
in a case where the parameter value of the first pixel is within a parameter interval of a first sub-model, determining that the first pixel matches the first sub-model, the first sub-model being at least one sub-model of the one or more sub-models of the second pixel corresponding to the first pixel; and
in a case where the parameter value of the first pixel is outside the parameter interval of the first sub-model, determining that the first pixel does not match the first sub-model.

4. The method according to claim 1, wherein the preset tracking model includes at least one neural network model; and the inputting the foreground image and at least one comparison image into a preset tracking model to obtain at least one tracking result includes:
inputting the foreground image into a first neural network model to obtain a first image feature of the foreground image, the first neural network model being any neural network model in the at least one neural network model;
inputting each of the at least one comparison image into a second neural network model to obtain a second image feature corresponding to each comparison image of the at least one comparison image, the second neural network model being any neural network model except the first neural network in the at least one neural network model; and
comparing the first image feature with the second image feature corresponding to each comparison image to obtain the at least one tracking result.

5. The method according to claim 1, wherein the at least one tracking result includes at least one of a first parameter value, a range of a tracking image, or a tracking position; wherein the tracking image is a sub-image with a highest similarity to the foreground image in the comparison image, the first parameter value is used to indicate a similarity between the foreground image and the tracking image, and the range of the tracking image is a region occupied by the tracking image in the comparison image, and the tracking position is a position of the tracking image in the comparison image.

6. The method according to claim 5, wherein the detecting whether the foreground object is an object left behind in the target region according to the at least one tracking result includes:
in a case where the at least one tracking result satisfies a second preset condition, determining that the foreground object is the object left behind in the target region, the second preset condition including at least one restrictive condition that corresponds to the at least one tracking result; and
in a case where any one of the at least one tracking result does not satisfy the second preset condition, determining that the foreground object is not the object left behind in the target region.

7. The method according to claim 6, wherein the determining that the foreground object is the object left behind in the target region in a case where the at least one tracking result satisfies a second preset condition includes:
in a case where the first parameter value is greater than a third threshold, and/or the range of the tracking image is greater than a fourth threshold, and/or the tracking position is within at least one preset range in the comparison image, determining that the foreground object is the object left behind in the target region.

8. The method according to claim 1, wherein before the inputting the foreground image and at least one comparison image into a preset tracking model to obtain at least one tracking result, the method further comprises:
acquiring one or more background images; and
determining a background sub-image of each background image of the one or more background images, a position of the background sub-image in the background image corresponding to a position of the foreground image in the first to-be-detected image;
inputting the foreground image and the one or more background sub-images into a verification model to obtain at least one second parameter value, the second parameter value is used to indicate a similarity between the foreground image and the background sub-image; and
in a case where the at least one second parameter value is less than a fifth threshold, determining that the foreground image exists in the first to-be-detected image.

9. The method according to claim 1, wherein further comprising:
in a case where the foreground image does not exist in the first to-be-detected image, or the foreground image does not satisfy the first preset condition, or the foreground object is not the object left behind in the target region, updating the foreground image determination model.

10. The method according to claim 9, wherein the updating the foreground image determination model in a case where the foreground image does not exist in the first to-be-detected image, or the foreground image does not satisfy the first preset condition, or the foreground object is not the object left behind in the target region includes:
determining an updated image, the updated image being the first to-be-detected image; and
updating the foreground image determination model according to the updated image to obtain an updated foreground image determination model.

11. The method according to claim 10, wherein the foreground image determination model includes one or more sub-models corresponding to a position of each pixel in the background image of the target region, and each sub-model corresponds to a weight value; and the method further comprises:
for each third pixel in the updated image, detecting whether a sub-model matching the third pixel exists in one or more sub-models corresponding to a second pixel, the second pixel being a pixel corresponding to a position of the third pixel in the background image; and
the updating the foreground image determination model according to the updated image to obtain an updated foreground image determination model including:
in a case where a second sub-model exists in the one or more sub-models, increasing a weight value of the second sub-model and decreasing a weight value of a third sub-model, the second sub-model being the sub-model matching the third pixel in the one or more sub-models, and the third sub-model being a sub-model except the second sub-model in the one or more sub-models; and
obtaining the updated foreground image determination model according to an increased weight value of the second sub-model and a decreased weight value of the third sub-model.

12. The method according to claim 11, wherein the updating the foreground image determination model according to the updated image to obtain an updated foreground image determination model includes:
in a case where the second sub-model does not exist in the one or more sub-models, generating a fourth sub-model according to the third pixel; and
replacing a sub-model with a minimum weight value in the one or more sub-models with fourth sub-model to obtain the updated foreground image determination model.

13. The method according to claim 1, further comprising:
acquiring a second to-be-detected image of the target region at a second moment, the second moment being a moment after the first moment;
determining whether the foreground image exists in the second to-be-detected image according to the foreground image determination model;
in a case where the foreground image exists in the second to-be-detected image and the foreground image satisfies a first preset condition, inputting the foreground image and at least one second comparison image into the preset tracking model to obtain at least one tracking result, wherein the at least one second comparison image is an image of the target region within a third time period, the third time period is a time period after the second moment, and the first preset condition includes at least one of: a ratio of the area of the foreground image to an area of the second to-be-detected image being greater than the first threshold, and the number of pixels of the foreground image being greater than the second threshold; and
detecting whether the foreground object is the object left behind in the target region according to the at least one tracking result.

14. The method according to claim 1, further comprising:
in a case where the foreground object is the object left behind in the target region, outputting prompt information.

15. (canceled)

16. A left-behind object detection apparatus, comprising a processor and a communication interface, the communication interface being coupled to the processor, and the processor being used to run a computer program or instructions to implement the method for left-behind object detection according to claim 1.

17. A left-behind object detection system, comprising a left-behind object detection apparatus and at least one camera device, the left-behind object detection apparatus being used to perform the method for left-behind object detection according to claim 1.

18. A non-transitory computer-readable storage medium, wherein the non-transitory computer-readable storage medium has stored thereon instructions that, when executed by a computer, cause the computer to perform the method for left-behind object detection according to claim 1.

19. A computer program product being stored on a non-transitory computer-readable storage medium and comprising computer program instructions that, when executed by a computer, cause the computer to perform the method for left-behind object detection according to claim 1.

20. The apparatus according to claim 16, further comprising a memory for storing the computer program or the instructions.

21. The apparatus according to claim 16, wherein the left-behind object detection apparatus is a chip.
